(19) United States
(12) Patent Application Publication
(10) Pub. No.: US 2004/0258914 A1
(43) Pub. Date: Dec. 23, 2004

(54) Enhanced metal ion release rate for anti-microbial applications

(75) Inventors: N. Satish Chandra, Lansdale, PA (US); Vinesh Naik, DuPont, PA (US)

Correspondence Address: AKERMAN SENTERFITT, P.O. BOX 3188, WEST PALM BEACH, FL, 33402-3188, US

(73) Assignee: Noble Fiber Technologies, Inc., Clarks Summit, PA

(21) Appl. No.: 10/836,530

(22) Filed: Apr. 30, 2004

Related U.S. Application Data
(60) Provisional application No. 60/467,678, filed on May 2, 2003.

(51) Int. Cl. B32B 3/00

(52) U.S. Cl. 428/375

(57) ABSTRACT

A method for enhancing the metal ion release rate of a substrate having a coating of a metal thereon. The method includes the steps of forming the metal-coated substrate and then subjecting the metal-coated substrate to a step that removes portions of the metal coating to form at least one notch in the metal coating, thereby increasing the surface area of the metal coating. The increased surface area enhances the metal ion release rate of the substrate. The metal may be silver. A silver-coated substrate may be used in the formation of medical products having increased antimicrobial and/or anti-fungal characteristics.

### CROSS REFERENCE TO RELATED APPLICATION

This application claims the priority of U.S. provisional patent application No. 60/467,678, filed May 2, 2003.

### STATEMENT AS TO FEDERALLY SPONSORED RESEARCH

Not applicable.

### FIELD OF THE INVENTION

The invention relates to the field of metal coating technology. More particularly, the invention relates to articles of manufacture and methods of making the same for the increasing the anti-microbial and/or anti-fungal characteristics of metal-coated substrates.

### BACKGROUND OF THE INVENTION

There has been a great deal of attention in recent years given to the hazards of bacterial contamination from potential everyday exposure. With such an increased consumer interest in this area, manufacturers have begun introducing antimicrobial agents within various household products and articles. For instance, certain brands of polypropylene cutting boards, liquid soaps, etc., all contain antimicrobial compounds.

In addition, the risk of bacterial infection is also prevalent in medical instances. For example, a variety of medical articles are designed particularly for contact with a patient's bodily fluids. The duration of this contact may be relatively short, as is typical with wound dressings, or may be long term, as is typical with prosthetic heart valves implanted into the body of a recipient. Some articles such as catheters may have either short term or relatively long term contact. Other articles typically having relatively short term contact with the patient include, without limitation, burn dressings and contact lenses. Other articles typically having long term contact with a patient include, without limitation, implanted prostheses.

Contact of articles with bodily fluids creates a risk of infection. This risk may be very serious and even life threatening. In addition, considerable costs, and longer or additional hospital stays may result due to infection. For example, infections associated with dressings may increase the seriousness of the injury for burn victims. Also, infection associated with an implanted prosthesis may necessitate replacement of the device.

Accordingly, the prior art has attempted to examine methods to help reduce the risk of bacterial infection and/or to prevent infection from even occurring. One approach has been through the use of anti-microbial agents and/or microbiocides.

The most popular antimicrobial for many articles is triclosan. Although the incorporation of such a compound within liquid or polymeric media has been relatively simple, other substrates, including the surfaces of textiles and fibers, have proven less accessible. There has a long-felt need to provide effective, durable, and long-lasting antimicrobial characteristics for textile surfaces, in particular on apparel fabrics, and on film surfaces. Such proposed applications have been extremely difficult to accomplish with triclosan, particularly when wash durability is a necessity (triclosan easily washes off any such surfaces). Furthermore, although triclosan has proven effective as an antimicrobial compound, the presence of chlorines within such a compound causes skin irritation which makes the utilization of such with fibers, films, and textile fabrics for apparel uses highly undesirable.

Furthermore, there are commercially available textile products comprising acrylic and/or acetate fibers co-extruded with triclosan (for example Celanese markets such acetate fabrics under the name Microsafe™ and Acordis markets such acrylic fibers, under the tradename Amicor™). However, such an application is limited to those types of fibers; it does not work at all for natural fibers and specifically does not work for and/or within polyester, polyamide, cotton, spandex, etc., fabrics. Furthermore, this co-extrusion procedure is very expensive.

Silver-containing inorganic microbiocides have recently been developed and utilized as antimicrobial agents on and within a plethora of different substrates and surfaces. In particular, such microbiocides have been adapted for incorporation within melt spun synthetic fibers, as taught within Japanese unexamined Patent Application No. H11-124729, to provide certain fabrics which selectively and inherently exhibit antimicrobial characteristics. Furthermore, attempts have been made to apply such specific microbiocides on the surfaces of fabrics and yarns with little success from a durability standpoint. A topical treatment with such compounds has never been successfully applied as a durable finish or coating on a fabric or yarn substrate.

Although such silver-based agents provide excellent, durable, antimicrobial properties, to date such is the sole manner available within the prior art of providing a long-lasting, wash-resistant, silver-based antimicrobial textile. However, such melt spun fibers are expensive to make due to the large amount of silver-based compound required to provide sufficient antimicrobial activity in relation to the migratory characteristics of such a compound within the fiber itself to its surface.

Additionally, many silver-containing materials are difficult and/or expensive to make due to the processes currently existing in the art for coating a fiber with a metal, such as silver.

Methods for electroless deposition of metals on a variety of substrate materials have been known since the earliest use of aldehydes to precipitate silver from solutions containing silver salts. More recently, the use of electroless plating methods has received attention following the discovery that some alloys, such as electroless deposited nickel phosphorus alloys, possess unique properties, and because of the growing use of such methods for plating plastics, and manufacturing optical, electronic and optoelectronic devices.

Electroless plating solutions usually contain a metal salt, a reducing agent, a pH adjuster, a complexing agent, and one or more additives to control properties including bath stability, film properties, and metal deposition rate. An ideal electroless plating solution deposits metal only on an immersed article, never as a film on the sides of the tank or as a fine powder. All parts of an immersed article must have been thoroughly cleaned before plating. The presence of dirt or oxide on an article may either interfere with uniform deposition or lead to loss of adhesion of the metal deposit.

Application of metal to non-conductors requires the presence of a seed material in contact with the surface of a thoroughly cleaned article to provide a catalytic site for electroless metal deposition. Activation of a surface of non-conducting and dielectric materials for electroless metal plating commonly uses solutions containing acidic stannous chloride and acidic palladium chloride. The original catalysts were separate solutions with acidic stannous chloride acting as a reducing agent for subsequently applied palladium chloride to produce catalytic sites of metallic palladium at the surface of a cleaned article. It is the physical presence and chemical activity of the palladium that is a prerequisite for initiation of the electroless plating process. The two-step catalyst system may be replaced by a catalyst solution containing pre-reacted palladium and stannous chlorides.

U.S. Pat. No. 3,632,435 confirms the use of tin and palladium salts for surface activation and further includes the use of salts of other noble metals in the place of palladium. This reference also addresses deactivation or masking of selected portions of a catalyzed surface that was activated using stannous and palladium ions as previously described. Deactivation, in this case, involves the application of destabilizing agents. One category of destabilizing agents includes polyvalent hydrolysable metal ions, such as lead, iron and aluminum, which have the capacity to oxidize stannous ions to stannic ions. Stannic ions do not react with palladium solutions to produce catalytic sites of elemental palladium for deposition of electroless metal layers. In certain other literature, the use of only stannous chloride is mentioned for activation of silver-metallization process.

Chelating agents for noble metals include organic compounds, e.g. dibasic acids, containing acid functionality to provide another type of destabilizing agent according to U.S. Pat. No. 3,632,435. The acidic chelating agent acts primarily on the noble metal, e.g. palladium, of a catalyzed surface to mask its catalytic behavior thereby preventing electroless metal deposition in treated areas. Acid treatment may be used in other cases to facilitate electroless plating of an overcoat plating on metal conductors while preventing metal deposition on dielectric material surrounding the metal conductors. U.S. Pat. No. 5,167,992 uses a deactivator acid solution to remove noble metal ions from dielectric surfaces after treatment with solutions of noble metal salts. Suitable deactivator acids include organic acids and inorganic acids.

Nevertheless, these methods do not achieve a metal-coated fiber or material that is capable of releasing a higher percentage of metal ions during an initial period of time. Additionally, for those embodiments wherein the metal is silver and the product is used for its anti-microbial and/or anti-fungal properties, these methods do not achieve higher release of silver ions.

Accordingly, what is needed is a method of coating a fiber or other substrate such that the metal coating is designed to release a higher percentage of metal ions during an initial period of time. Also, what is needed is a silver-coated fiber or substrate that may be used in a product that is used for its anti-microbial and/or anti-fungal properties, thereby increasing the effectiveness of the silver-coated substrate due to a higher release of silver ions in an initial period of time.

### SUMMARY OF THE INVENTION

The present invention is directed to an article of manufacture and a method of making the same, wherein the article is a substrate having a metal coating thereon, further wherein the surface area of the metal coating has been increased such that a larger amount of metal ions may be released over a period of time as compared to conventional metal-coated fibers. In select embodiments, the substrate has a silver coating and is used in medical applications for its anti-microbial and/or anti-fungal properties. In other embodiments, the substrate is a fiber and the silver-coated fiber encompasses all or a portion of the final article having anti-microbial and/or anti-fungal properties.

In particular, the present invention provides a method of coating a metal, such as silver, onto a fiber or other substrate such that the metal-coated substrate will release a higher percentage of the metal ions during an initial period of time. As such, for those embodiments wherein the metal is silver, the effectiveness of the anti-microbial and/or anti-fungal properties of the silver-coated substrate will be increased. It may also be used to provide an immediate zone of protection against a hostile environment.

More particularly, the present invention provides a method of coating a metal on a substrate including the steps of applying a coating of a metal onto the surface of the substrate; and increasing a surface area of the metal-coated substrate.

In another aspect, the present invention provides an article of manufacture made from a process including the steps of applying a coating of a metal onto the surface of the substrate; and increasing a surface area of the metal-coated substrate.

In yet another aspect, the present invention provides an article of manufacture having a substrate having a metal coating thereon; wherein the metal coating includes at least one notch in the metal coating that increases the surface area of the metal coating on the substrate.

### DETAILED DESCRIPTION OF THE INVENTION

The present invention is more particularly described in the following description and examples that are intended to be illustrative only since numerous modifications and variations therein will be apparent to those skilled in the art. As used in the specification and in the claims, the singular form “a,” “an,” and “the” may include plural referents unless the context clearly dictates otherwise. The term “comprising” may include the embodiments “consisting of” and “consisting essentially of.”

The invention provides a substrate having a metal coating thereon, further wherein the surface area of the metal coating has been increased such that a larger amount of metal ions may be released over a period of time as compared to conventional metal-coated substrates. The present invention also provides a method of making a metal-coated substrate having an increased surface area.

In select embodiments, the substrate has a silver coating and is used in medical applications for its anti-microbial and/or anti-fungal properties wherein due to the increased surface area of the silver-coated substrate, a higher percentage of silver ions are released in an initial period of time after application of the silver-coated substrate, thereby increasing the effectiveness of the anti-microbial and/or anti-fungal properties of the silver-coated substrate.

The present invention provides a method of enhancing the surface area of a metal-coated substrate to increase the amount of metal ions that are initially released when the metal-coated substrate is used in an article. As such, the present invention includes one or more of the following steps: preparing the surface area of the substrate for application of a metal coating; applying a coating of a metal onto the substrate; and enhancing the surface area of the metal-coated substrate. The step of preparing the surface area of the substrate for application of a metal coating may not be necessary for certain embodiments, depending on the substrate to be coated and/or the type of metal being coated, among other factors.

In the method of the present invention, the substrate to be coated may be selected from any substrate onto which it is beneficial to place a metal coating. Examples of substrate useful in the present invention include, but are not limited to, yarns, films, filaments, fibers, fabrics, staple fibers, chopped fibers, micronized fibers, foam, filler materials, and a combination thereof.

The materials used for the substrates may be any material capable of having a metal coating applied thereto including, but not limited to, nylon, polyester, acrylic, rayon, polyurethane, other polymeric materials, cellulose materials, such as wood fiber, or a combination thereof.

Once the substrate has been selected, it may be beneficial to prepare the substrate for the application of the metal coating. Depending on the substrate and the metal to be coated, the substrate may be scoured to enhance the application of the metal coating to the substrate. In one embodiment, the substrate is scoured by application of a surfactant. The surfactant may be anionic, cationic, non-ionic, or a combination thereof. The surfactant may be applied by spraying, coating, dipping, immersing, or otherwise contacting the substrate with the surfactant. If a surfactant is used, the fiber may then be washed, such as with hot and/or cold water, to remove any excess surfactant.

In another embodiment, the substrate may be prepared to receive the metal coating by treating the substrate such that the metal coating better adheres to the surface of the substrate. The substrate may be washed with a metal salt and an acid to help prepare the substrate. Any metal salt and/or acid capable of preparing a substrate to receive a metal coating thereon may be used in the present invention. Useful metal salts include, but are not limited to, stannous chloride. Useful acids include, but are not limited to, muriatic acid or hydrochloric acid.

The amounts of metal salt and acid used may vary. In one embodiment, the metal salt is used in an amount of from about 1 to about 100 g/l. In another embodiment, the metal salt is used in an amount of from about 2 to about 90 g/l. In yet another embodiment, the metal salt is used in an amount of from about 10 to about 80 g/l. In still another embodiment, the metal salt is used in an amount of about 50 g/l.

In another embodiment, the acid is used in an amount of from about 1 to about 20 g/l. In another embodiment, the acid is used in an amount of from about 3 to about 18 g/l. In yet another embodiment, the acid is used in an amount of from about 6 to about 15 g/l. In still another embodiment, the acid is used in an amount of about 5 g/l.

After the substrate has been pre-treated, or if the coating is applied without any pre-treatment, the substrate is coated with the metal coating. The metal used in the coating may be any metal capable of being coated onto a fiber. Examples of metals useful in the present invention include, but are not limited to, copper, zinc, silver, gold, nickel, aluminum, or a combination thereof. In select embodiments, the metal is silver.

The metal coating may be applied by spraying, coating, immersing, dipping or otherwise contacting the substrate with a solution containing the metal or metals to be coated onto the substrate. The solution is formed by mixing a metal compound with a catalyst to form a metal oxide precipitate. The metal oxide precipitate is then dissolved in a solvent to form a metal-solvent complex. A reducing agent may then be used to precipitate the metal onto the substrate to form the metal-coated substrate of the present invention.

The amounts of metal compound and catalyst used may vary. In one embodiment, the range of the ratio of the metal compound to the catalyst may be from about 0.25:2 to about 1.75:2, as based on the number of moles. In another embodiment, the range of the ratio of the metal compound to the catalyst may be from about 0.5:2 to about 1.5:2, as based on the number of moles. In yet another embodiment, the range of the ratio of the metal compound to the catalyst may be from about 0.75:2 to about 1.25:2, as based on the number of moles. In still another embodiment, the range of the ratio of the metal compound to the catalyst may be about 1:2.

In another embodiment, the catalyst makes up about 17 to about 38% of the metal solution. In another embodiment, the catalyst makes up about 20 to about 35% of the metal solution. In yet another embodiment, the catalyst makes up about 25 to about 31% of the metal solution. In still another embodiment, the catalyst makes up about 28% of the metal solution.

The mixture of the metal compound and the catalyst enables the formation of a metal oxide precipitate. The metal oxide precipitate may then be dissolved using a solvent to form a metal-solvent complex. The ratio of the solvent to the metal compound may vary. In one embodiment, the ratio of the solvent to the metal compound may range from about 2.5:1 to about 5.5:1, based on the number of moles solvent to moles of metal compound. In another embodiment, the ratio of the solvent to the metal compound may range from about 3:1 to about 5:1, based on the number of moles solvent to moles of metal compound. In yet another embodiment, the ratio of the solvent to the metal compound may range from about 3.5:1 to about 4.5:1, based on the number of moles solvent to moles of metal compound. In still another embodiment, the ratio of the solvent to the metal compound may be from about 4:1, based on the number of moles solvent to moles of metal compound.

The method uses a solvent capable of dissolving the metal and/or forming a metal-solvent complex. Any solvent capable of dissolving a metal and/or forming a metal-solvent complex may be used in the present invention. Useful solvents include, but are not limited to, ammonia.

The substrate is contacted with the solution containing the metal-solvent complex and a reducing agent is added to help precipitate the metal onto the substrate to form the metal coating. The amount of metal in the solution may vary based upon the weight of the sample. In one embodiment, the weight of metal in the solution to the weight of the substrate is from about 0.1 to about 100%. In another embodiment, the weight of metal in the solution to the weight of the substrate is from about 3 to about 90%. In yet another embodiment, the weight of metal in the solution to the weight of the substrate is from about 20 to about 65%. In still another embodiment, the weight of metal in the solution to the weight of the substrate is from about 25 to about 50%.

The method uses a reducing agent capable of causing the metal to precipitate onto the substrate. Any reducing agent that is capable of causing a particular metal to precipitate onto a substrate may be used. Useful reducing agents include, but are not limited to, formaldehyde.

Once the metal-coated substrate has been formed, the substrate may be washed to remove excess solution and or reducing agent.

The temperature of the process does not generally need to be controlled as the metallizing temperature may vary from about 15 to about 45° C. The length of time for the metal to be precipitated onto the substrate may vary, but generally takes less than about 4 hours. The amount of metal deposited onto the substrate may be from about 1 to about 50%, depending on the specific characteristics of the final product. The exact amount of silver deposited may be calculated by simple titration, such as using the Vollard Process.

Once the metal-coated substrate has been formed, the surface area of the metal coating on the substrate is enhanced or increased, thereby permitting a larger percentage of metal ions to be released from the substrate during an initial period of time. This step may be accomplished by using an acid solution with which the metal-coated substrate is contacted, such as by spraying, coating, dipping, or immersing, wherein the acid removes portions of the metal coating to form pits, pockets or notches in the metal coating. The acid is selected such that it does not remove an entire section of the coating, thereby creating exposed areas of the substrate. Rather, the acid only removes portions of the coating, thereby causing the substrate to remain coated with a layer of metal having varying degrees of thickness. The acid also forms micro-pits that further enhance the surface area of the coating.

The amount of acid in the solution may vary. In one embodiment, the solution includes from about 0.1 to about 50% acid. In another embodiment, the solution includes from about 1 to about 25% acid. In yet another embodiment, the solution includes from about 2 to about 12% acid. In still another embodiment, the solution includes about 5% acid.

The acid may be any acid capable of removing or dissolving the particular metal that has been used to coat the substrate. For example, if silver was the metal, the acid may be sulfuric acid. Other acids include, but are not limited to, organic acids.

The methods of the present invention produce a metal-coated substrate having an enhanced surface area. The enhanced surface area permits a higher release of metal ions during an initial period of time and/or to hold the high release of ions over a extended period of time. This would enable for an optimum amount of ions to get to the target area especially when there are barriers such as hydrophobic layers or multiple layers to get through. As such, the metal-coated substrate may be used in embodiments wherein it is beneficial to have a release of the metal ions and in embodiments wherein an increase in the rate of release of the metal ions is also beneficial. One example is the use of a silver-coated substrate in an article utilizing the antimicrobial and/or anti-fungal characteristics of the silver, such as a wound dressing, bandage, gauze or other medical product applied to a wound, burn or other injury to help heal the injury. By having a higher rate of release of silver ions, the medical product increases the antimicrobial and/or anti-fungal characteristics of the medical product, thereby increasing the effectiveness of the medical product at killing any microbes, bacteria and/or fungi to better enable the injury to heal.

The amount of metal-coated substrate used in the final article may vary depending on a variety of factors including, but nor limited to, the type of article, the intended use of the article, the type of metal, and the beneficial characteristics of the metal. In general, while there may be embodiments having 100% metal-coated substrate, it is contemplated that the final article will have from about 1 to about 50% of metal-coated substrate, and from about 50 to about 99% of non-metal coated materials. In other embodiments, the final article will have from about 2 to about 20% of metal-coated substrate, and from about 80 to about 98% of non-metal coated materials. In yet other embodiments, the final article will have from about 3 to about 10% of metal-coated substrate, and from about 90 to about 97% of non-metal coated materials. In select embodiments, the final article will have from about 5% of metal-coated substrate, and about 95% of non-metal coated materials.

The metal-coated substrates of the present invention have enhanced surface areas to permit a higher percentage of metal ions to be released from the substrate over an initial period of time. As such, the enhanced surface area may increase the rate of metal ion release from about 5 to about 50% in the first 24 hours of use of the substrate. In other embodiments, the enhanced surface area may increase the rate of metal ion release from about 10 to about 30% in the first 24 hours of use of the substrate. In certain embodiments, the increase of the ion release rate for a product for which surface area has been enhanced, when compared to a product for which surface area has not been enhanced, is on the order of magnitude or even higher.

The present invention will now be further described through examples. It is to be understood that these examples are non-limiting and are presented to provide a better understanding of various embodiments of the present invention.

### EXAMPLES

### Example 1

Foam made up of polyurethane (4″×4″) and 0.3″ thick was immersed in pre-metallizing solution of 50 gm/l of stannous chloride and 5% muriatic acid for 2 minutes. After rinse, sample was immersed in 25% by weight of silver in silver-ammonia complex for 2 minutes.

A bath prepared with 2 drops of surfactant and 500 ml of de-ionized water dissolved completely. The foam was is then immersed into the bath and about 10 drops of formaldehyde was added. The solution was stirred well and after 1 hour the sample was pulled out of the bath, rinsed thoroughly and then dipped in a mild caustic soda solution. The sample was then subjected to surface enhancing technique by dipping in 5% sulfuric acid solution for approximately 1 minute. Series of thorough rinsing follows this step to remove sulfuric acid from the substrate. Sample may then dried or may be sent into silver release test right away.

Release of Silver ions (24 hours) of up to 75 mg/l (Test for release may be done by immersing sample into de-ionized water for 24 hours and then checked water for solver using Atomic Absorption Instrument.)

### Example 2

Sample obtained from Example 1 (prior to surface area enhancing) was immersed in 6% silver in silver ammonia complex by weight of sample. Couple of drops of formaldehyde was used to effect reducing of silver. Reaction was on for 30 minutes and then sample was dried and surface area enhancing steps were performed as Example 1.

Release of Silver ions (24 hours) of up to 75 mg/l (Test for release may be done by immersing sample into de-ionized water for 24 hours and then checked water for silver using Atomic Absorption Instrument.)

### Example 3

Sample obtained from Example 1 prior to addition of formaldehyde and surfactant was subjected to surface area enhancing techniques as described in Example 1.

Release of Silver ions (24 hours) of up to 15 mg/l (Test for release may be done by immersing sample into de-ionized water for 24 hours and then checked water for silver using Atomic Absorption Instrument.)

### Example 4

Sample obtained from regular metallizing process was subjected to surface area enhancing techniques as described in Example 1.

Release of Silver ions (24 hours) of up to 75 mg/l (Test for release may be done by immersing sample into de-ionized water for 24 hours and then checked water for silver using Atomic Absorption Instrument.)

Table 1 provides the release rate, in ppm, of silver ions, over a period of time for various materials that have a coating of silver thereon, but wherein the surface area of the materials has not yet been enhanced. The materials listed are varying numbers of fibers having different total dernier. For example, 20-3 fibers having 20 total dernier. 40-13 is 13 fibers having 40 total dernier. These materials were coated with silver in the manner previously described in the examples but without any subsequent surface area enhancement step.

Table 2 provides the release rate, in ppm, of silver ions, over a period of time for various materials that have a coating of silver thereon and have had the surface area of the silver enhanced by the methods of the present invention. The materials listed are Medisponge 50, a medical grade sponge, Nolasponge, another sponge, spandex, 34 fibers having 100 total dernier, and a spacer fabric having 13 fibers having 34 total dernier. As can be seen, the materials having the enhanced surface area had significantly higher release rates of silver ion versus the non-enhanced materials.

TABLE 1

| | 24 | 48 | 72 | 96 | 120 |
|---|---|---|---|---|---|
| Material | hrs | hrs | hrs | hrs | hrs |
| 20-3 | 0.248 | 0.214 | 0.197 | 0.174 | 0.17 |
| 30-10 | 0.311 | 0.301 | 0.287 | 0.255 | 0.248 |
| 40-13 | 0.344 | 0.312 | 0.301 | 0.277 | 0.255 |
| 70-34F | 0.323 | 0.309 | 0.291 | 0.288 | 0.287 |
| 70-34Tx | 0.319 | 0.319 | 0.305 | 0.307 | 0.298 |
| 100-34 | 0.411 | 0.408 | 0.405 | 0.395 | 0.388 |
| 210-34 | 0.455 | 0.443 | 0.392 | 0.388 | 0.345 |
| Staple | 0.289 | 0.278 | 0.255 | 0.245 | 0.233 |
| Spandex | 0.195 | 0.195 | 0.187 | 0.176 | 0.167 |
| Chopped | 0.275 | 0.265 | 0.243 | 0.233 | 0.201 |
| fiber | | | | | |

TABLE 2

| | | | | | Spacer |
|---|---|---|---|---|---|
| | | | | | Fabric |
| Time | Medisponge | | | | with |
| (Hrs) | 50 | Nolasponge | Spandex | 100-34 | 40-13 |
| 24 | 60 | 38 | 5 | 12 | 2 |
| 48 | 68 | 46 | 7 | 20 | 4 |
| 72 | 68 | 46 | 8 | 21 | 4 |
| 96 | 78 | 51 | 9 | 23 | 6 |
| 120 | 82 | 54 | 11 | 25 | 7 |

Although the illustrative embodiments of the present disclosure have been described herein with reference to the accompanying examples, it is to be understood that the disclosure is not limited to those precise embodiments, and various other changes and modifications may be affected therein by one skilled in the art without departing from the scope of spirit of the disclosure. All such changes and modifications are intended to be included within the scope of the disclosure as defined by the appended claims.

1. A method of coating a metal on a substrate comprising:
applying a coating of a metal onto the surface of the substrate; and
increasing a surface area of the metal-coated substrate.

2. The method of claim 1, further comprising the step of:
applying a surfactant to a surface of the substrate prior to applying the metal coating;
wherein the surfactant is selected from a non-ionic surfactant, an anionic surfactant, a cationic surfactant, and a combination thereof.

3. The method of claim 1, wherein the metal is selected from silver, copper, zinc, gold, aluminum, nickel, and a combination thereof.

4. The method of claim 3, wherein the metal is silver.

5. The method of claim 1, wherein the surface area of the metal-coated substrate is increased by subjecting the metal-coated substrate to a material that partially removes a portion of the metal coating, thereby forming at least one notch in the metal coating that increases the surface area of the metal coating on the substrate.

6. The method of claim 5, wherein the material that partially removes a portion of the metal coating is an acid capable of removing a portion of the metal coating.

7. The method of claim 6, wherein the acid is sulfuric acid.

8. The method of claim 1, wherein the substrate is selected from a yarn, film, filament, fiber, fabric, staple fiber, chopped fiber, micronized fiber, foam, filler material, and a combination thereof.

9. An article of manufacture made from a process comprising the steps of:
applying a coating of a metal onto the surface of the substrate; and
increasing a surface area of the metal-coated substrate.

10. The article of claim 9, further comprising the step of:
applying a surfactant to a surface of the substrate prior to applying the metal coating;
wherein the surfactant is selected from a non-ionic surfactant, an anionic surfactant, a cationic surfactant, and a combination thereof.

11. The article of claim 9, wherein the metal is selected from silver, copper, zinc, gold, aluminum, nickel, and a combination thereof.

12. The article of claim 11, wherein the metal is silver.

13. The article of claim 9, wherein the surface area of the metal-coated substrate is increased by subjecting the metal-coated substrate to a material that partially removes a portion of the metal coating, thereby forming at least one notch in the metal coating that increases the surface area of the metal coating on the substrate.

14. The article of claim 13, wherein the material that partially removes a portion of the metal coating is an acid capable of removing a portion of the metal coating.

15. The article of claim 14, wherein the acid is sulfuric acid.

16. The article of claim 9, wherein the substrate is selected from a yarn, film, filament, fiber, fabric, staple fiber, chopped fiber, micronized fiber, foam, filler material, and a combination thereof.

17. An article of manufacture comprising:
a substrate having a metal coating thereon;
wherein the metal coating includes at least one notch in the metal coating that increases the surface area of the metal coating on the substrate.

18. The article of claim 17, wherein the metal is selected from silver, copper, zinc, gold, aluminum, nickel, and a combination thereof.

19. The article of claim 18, wherein the metal is silver.

20. The article of claim 17, wherein the substrate is selected from a yarn, film, filament, fiber, fabric, staple fiber, chopped fiber, micronized fiber, foam, filler material, and a combination thereof.
